(19) United States
(12) Patent Application Publication
(10) Pub. No.: US 2003/0167798 A1
(43) Pub. Date: Sep. 11, 2003

(54) Optical members and methods for predicting the performance of optical members and optical systems

(75) Inventors: Nicholas F. Borrelli, Elmira, NY (US); Michael R. Heslin, Victor, NY (US); Michael W. Linder, Corning, NY (US); Johannes Moll, Painted Post, NY (US); Charlene M. Smith, Corning, NY (US)

Correspondence Address: CORNING INCORPORATED, SP-TI-3-1, CORNING, NY, 14831

(73) Assignee: CORNING INCORPORATED

(21) Appl. No.: 10/382,816

(22) Filed: Mar. 5, 2003

Related U.S. Application Data
(60) Provisional application No. 60/361,970, filed on Mar. 5, 2002.

(51) Int. Cl. C03B 5/26; G05B 1/00

(52) U.S. Cl. 65/29.11; 65/29.18

(57) ABSTRACT

Optical members, methods of manufacturing optical members and predicting the performance of optical members in optical systems using excimer lasers are disclosed. The methods can be used in designing optical systems using excimer lasers. The methods include measuring the wavefront change of samples of glass at the operating wavelength of the optical system.

### CROSS REFERENCE TO RELATED APPLICAION

This application claims the benefit of priority of U.S. Serial No. 60/361,970, filed Mar. 5, 2002, entitled OPTICAL MEMBERS AND METHODS FOR PREDICTING THE PERFORMANCE OF OPTICAL MEMBERS AND OPTICAL SYSTEMS, of Borrelli et al.

### FIELD OF THE INVENTION

This invention relates to optical members. More particularly, the invention relates to optical members resistant to laser damage, predicting the performance of optical members and optical systems including fused silica optical members that are exposed to excimer lasers.

### BACKGROUND OF THE INVENTION

As practiced commercially, fused silica optical members such as lenses, prisms, photomasks and windows, are typically manufactured from bulk pieces of fused silica made in a large production furnace. In overview, silicon-containing gas molecules are reacted in a flame to form silica soot particles. The soot particles are deposited on the hot surface of a rotating or oscillating body where they consolidate to the glassy solid state. In the art, glass making procedures of this type are known as vapor phase hydrolysis/oxidation processes, or simply as flame hydrolysis processes. The bulk fused silica body formed by the deposition of fused silica particles is often referred to as a “boule,” and this terminology is used herein with the understanding that the term “boule” includes any silica-containing body formed by a synthetic process. Other types of optical members include optical glass for i-line optical systems and fluorine doped fused silica glass.

As the energy and pulse rate of lasers increase, the optical members such as lenses, prisms, photomasks and windows, which are used in conjunction with such lasers, are exposed to increased levels of laser radiation. Fused silica members have become widely used as the manufacturing material for optical members in such laser-based optical systems due to their excellent optical properties and resistance to laser induced damage.

Laser technology has advanced into the short wavelength, high energy ultraviolet spectral region, the effect of which is an increase in the frequency (decrease in wavelength) of light produced by lasers. Of particular interest are short wavelength excimer lasers operating in the UV and deep UV (DUV) wavelength ranges. Excimer laser systems are popular in microlithography applications, and the shortened wavelengths allow for increased line densities in the manufacturing of integrated circuits and microchips, which enables the manufacture of circuits having decreased feature sizes. A direct physical consequence of shorter wavelengths (higher frequencies) is higher photon energies in the beam due to the fact that each individual photon is of higher energy. In such excimer laser systems, fused silica optics are exposed to high energy photon irradiation levels for prolonged periods of time resulting in the degradation of the optical properties of the optical members.

It is known that laser-induced degradation adversely affects the performance of optical members by decreasing light transmission levels, altering the index of refraction, altering the density, and increasing absorption levels of the glass. Over the years, many methods have been suggested for improving the optical damage resistance of fused silica glass. It has been generally known that high purity synthetic fused silica prepared by such methods as flame hydrolysis, CVD-soot remelting process, plasma CVD process, electrical fusing of quartz crystal powder, and other methods, are susceptible to laser damage to various degrees.

Optical members made from fused silica that are installed in deep ultraviolet (DUV) microlithographic scanners and stepper exposure systems must be able to print circuits having submicron-sized features within microprocessors and transistors. State-of-the-art optical members require high transmission, uniform refractive index properties and low birefringence values to enable scanners and steppers to print leading-edge feature sizes.

Synthetic fused silica that contains hydrogen and exposed to lasers between 190 and 300 nm exhibits three effects that cause wavefront distortion. These three effects are compaction, expansion (which is also referred to in the literature as rarefaction) and a photorefractive effect. Compaction and expansion can be understood as density changes, and the resulting wavefront change is caused by the change in density. The photorefractive effect, however, is an index change that is not related to a density change but instead due to a change in the chemical structure of the material. Wavefront distortion is measured in using an interferometric technique.

Because optical systems utilizing fused silica elements such as lithography equipment are generally expected to achieve a lifetime of about 10 years or, in terms of laser exposure of the optical system 100 to 400 billion laser pulses, it is important to develop a fundamental understanding of the interaction of the fused silica material with the ultraviolet radiation and to use this understanding in the development of materials with improved resistance to laser damage. An understanding of this interaction will allow for the development of more robust and durable optical systems.

### SUMMARY OF INVENTION

One embodiment of the invention relates to optical members having high resistance to optical damage from ultraviolet radiation in the wavelength range between 100 and 400 nm. One particular embodiment, relates to a glass optical member exhibiting a predetermined photorefractive effect contribution to wavefront distortion or change. In certain embodiments, the photorefractive effect value is predetermined by adjusting a glass characteristic, for example, the hydrogen content in the glass. In some embodiments, the hydrogen content of the glass is adjusted or optimized to tailor or change the photorefractive effect. In other embodiments, the optical member has a preselected wavefront distortion value. In still other embodiments, fused silica optical members are provided that exhibit an optimized photorefractive effect so that the optical member exhibits an index change of less than 5 ppm when exposed to a 193 nm laser having a fluence of about 0.4 mj/cm²/pulse. Preferably, the index change under these operating conditions is less than 2.5 ppm, and more preferably the index change is less than 1 ppm.

Another embodiment of the invention relates to a method of predicting the performance of a fused silica glass optical member under exposure to ultraviolet radiation in optical systems including a laser operating at wavelength range between 100 and 400 nm. This embodiment involves measuring the laser induced wavefront change of a sample of the fused silica glass at the operating wavelength of the optical system and estimating the performance of the optical member over an extended period of use of the optical system. In preferred embodiments, the method includes determining the contribution of the photorefractive effect on the wavefront change of the sample. In certain embodiments, the wavefront change is measured with an interferometer at a wavelength of 193 nm, and in other embodiments, the wavefront change is measured at a wavelength of 248 nm.

If the performance of a fused silica glass optical member under exposure to ultraviolet radiation can be predicted, methods of manufacturing synthetic fused silica glass optical members such as for example by the flame hydrolysis process can be optimized. In one such method, the laser induced wavefront change in a test sample of fused silica at the operating wavelength of the optical system is measured and at least one other characteristic such as hydrogen content of the glass is measured. A relationship between the wavefront change and the characteristic of the sample can be determined and after determining a relationship, the manufacturing process can be adjusted so as to minimize the wavefront change in the fused silica glass. In one embodiment, the characteristic of the fused silica glass can be altered to modify the wavefront change or the contribution of the photorefractive effect to the wavefront change. For example, in one particular embodiment, the hydrogen content of the glass can be adjusted to change the contribution of the photorefractive effect on the wavefront change.

In other embodiments, methods of designing optical systems are provided. According to certain embodiment, optical members used in such optical systems are selected based on the wavefront changes of optical member samples measured at the operating wavelength of the optical system and using the selected optical member in the system.

The various embodiments of the present invention provide optical members including but not limited to fused silica optical members that have improved resistance to laser damage. By measuring the wavefront distortion or change in sample optical members and determining the glass parameters that affect the wavefront change, improved optical members can be manufactured and optical systems can be designed that have improved reliability and longer operating lifetimes.

Additional advantages of the invention will be set forth in the following detailed description. It is to be understood that both the foregoing general description and the following detailed description are exemplary and are intended to provide further explanation of the invention as claimed.

### DETAILED DESCRIPTION

According to certain embodiments of the present invention, the performance of optical members used in optical systems such as lithography equipment is optimized by minimizing the laser induced wavefront change in the optical member. Applicants have discovered that measurement of wavefront change at the 633 nm wavelength and the scaling method that has been traditionally used to estimate contribution of the photorefractive effect to the laser induced wavefront change in the deep ultraviolet region does not accurately predict the wavefront distortion at wavelengths below 400 nm, particularly at 193 nm or 248 nm.

As mentioned above, the laser induced wavefront distortion in fused silica containing hydrogen is a function of three effects. These three effects are compaction, expansion (or rarefaction) and a photorefractive effect. Compared to compaction, expansion is significant only at very low laser fluence. Compaction is the result of restructuring of the glass during laser exposure. However, the exact mechanism of how and why compaction occurs is not completely understood. Expansion is thought to be the result of radiation induced formation of β-hydroxyl (SiOH) in the glass. The formation of SiOH requires the presence of hydrogen, so the hydrogen content of the glass is one of the key parameters in determining its expansion behavior in addition to laser fluence. Furthermore, expansion may also involve a restructuring of the glass that involves the formation of OH. Both compaction and expansion occur simultaneously in an exposed piece of glass, and exposure conditions as well as the glass parameters determine which factor is more dominant.

The total density change in an exposed piece of glass is simply the sum of the compaction and expansion density changes, but it should be noted that measured density change in a sample is a function of the geometry of the glass element and the shape and size of the laser beam. The reason for this is that any surrounding unexposed glass will reduce the amount by which the exposed glass can densify or expand. The material property generally used to study density changes and to make comparisons between different experiments is the so-called “unconstrained” density change, i.e., the density change one would observe in the material in the absence of any constraining material surrounding the exposure region. Unconstrained density change is a material-specific property, independent of sample and laser beam size and shape.

Laser induced density change can be inferred by either measuring the laser induced wavefront distortion with an interferometer or by measuring the laser induced stress-birefringence. Since a density change also implies a change in the index of refraction of the glass, one can, in principle, use interferometry to measure the change of optical path length in the exposed material, and from that measurement deduce the density change. However, there is an additional index change due to a photorefractive effect that is not the result of a density change, and one can accurately measure density change using interferometry only if the magnitude of the photorefractive effect is known.

A second way to measure density change in a laser-exposed piece of glass is to measure laser-induced stress-birefringence. When the material density changes in the exposed region, stress builds up which can be measured as birefringence. The magnitude of the birefringence correlates with the magnitude of the density change, and the direction of the slow or fast axis of the birefringence indicates the sign of the density change (increase or decrease).

SiOH formation, as described above, leads to expansion and index decrease, but there is also an index increase associated with the formation of SiOH. The index decrease is not related to any density change and is suggested to be due to a photorefractive effect. The photorefractive effect has been observed in silica-germania fiber Bragg gratings, and the literature indicates that an increase in absorption at short wavelengths gives rise to an increased index at longer wavelengths. It has been seen that in some samples of glass, the birefringence pattern indicates a net density decrease, but the wavefront inside the damage spot measured interferometrically is retarded indicating an increase in optical path length. In the absence of the photorefractive effect, the measured wavefront inside the exposure region of a sample with net density decrease should be advanced, not retarded.

Unlike compaction and expansion, the photorefractive effect is not subject to constraint by surrounding unexposed material. Also, because it is not a density change, it does not contribute to stress birefringence, but only to optical wavefront distortion or change as measured interferometrically. Because of these differences, the photorefractive effect has to be treated separately from expansion, even though it is postulated that expansion and the photorefractive effect have the same fluence dependence. Total wavefront distortion and its sign (representing wavefront advancement or retardation) is a function of laser fluence, laser pulse length, number of laser pulses, internal material properties of the glass such as hydrogen content of the glass, sample size and shape, and laser beam size and shape.

Even though most applications for fused silica glass are in the deep ultraviolet (DUV) wavelength range, effects such as laser induced wavefront distortion and birefringence are typically measured interferometrically at 633 nm. If the stress and strain optical coefficients of the glass material are known, one can estimate the impact of density changes on wavefront and birefringence at 193 nm based on 633 nm measurements. However, applicants have discovered that it is not possible to use 633 nm measurements for determination of the photorefractive effect at 193 nm or 248 nm. The photorefractive effect exhibits a dispersion higher than that associated with the density-related index. Instead, the measurement of wavefront distortion must occur at the ultimate operating wavelength of the laser in the optical system in which the fused silica element is used.

To determine how the photorefractive effect scales from 633 nm to 193 nm, measurements of the wavefront distortion were done on fused silica samples using a Twyman-Green interferometer having a linearly polarized source and a 1 μJoule/cm²/pulse fluence. Two orthogonal measurements were made on each sample and Coming-Tropel phase measurement software was used to analyze the measurements. The measurements made at 633 nm were performed using an index matching fluid, which measured bulk index change; surface deformation does not contribute to the measurement. The 193 nm measurements were made in air, which measures the overall change in optical path length, including surface deformation. Surface contributions have to be subtracted to compare to the 633 nm data, and thus surfaces were measured at 633 nm. Four samples were analyzed at 193 nm with the results shown in Table I. The overall accuracy of the measurement of the bulk wavefront distortion is estimated to be about 0.005 waves (3 nm) for the 633 nm measurements and 0.04 waves (8 nm) for the 193 nm measurements. All of the samples were about 200 mm long, and the estimated measurement error is approximately 0.15 nm/cm at 633 nm and 0.4 nm/cm at 193 nm.

TABLE I

| | | | Wavefront | |
|---|---|---|---|---|
| | | | Distortion | Wavefront |
| | Pulses | Fluence | @ 633 nm | Distortion |
| Sample | (million) | (mj/cm²/pulse) | (nm/cm) | @ 193 nm (nm/cm) |
| 1 | 22941 | 0.037 | −1.49 | 1.26 |
| 2 | 4173 | 0.057 | −0.54 | 0.65 |
| 3 | 7718 | 0.087 | −0.98 | 2.31 |
| 4 | 2970 | 0.093 | 0 | 1.02 |

As shown in Table I, the wavefront distortion measured at 633 nm is negative and the wavefront distortion measured at 193 nm is positive. The photorefractive effect leads to a net wavefront retardation at 193 nm even though the material density decreased. Therefore, measurement of the wavefront distortion must be performed at the ultimate operating wavelength of the optical system, which for optical lithography systems is typically 193 nm or 248 nm. The results demonstrate that data for wavefront distortion measured at 633 μm may not be accurate for determining wavefront distortion at shorter wavelengths. While the limited data set above shows that the wavefront at 193 nm is retarded in each of the samples, by adjusting the hydrogen content and decreasing the fluence level of the laser, it is expected that optical members can exhibit a less retarded or an advanced wavefront. The present invention enables the accurate determination of the photorefractive effect contribution to wavefront change at wavelengths between 100 and 400 nm, which will in turn enable the adjustment of glass characteristics to provide optical members that have optimized wavefront distortion values.

The various embodiments of the present invention demonstrate that in the manufacture of fused silica optical elements and design of optical systems including fused silica optical elements, an interferometer operating at the wavelength of ultimate use, for example, 193 nm for ArF lithographic systems, must be used to accurately predict the laser induced wavefront change. Thus, according to the present invention, optical members can be provided that have minimized wavefront distortion by tailoring the magnitude of the photorefractive effect on the total wavefront distortion in the fused silica glass. The manufacturing processes for producing fused silica optical members can be modified to change the parameters such as hydrogen content that have an effect on the photorefractive effect. Such manufacturing process changes can include modification of the synthetic fused silica production process, or by using post glass formation treatments to modify parameters such as hydrogen content in the glass.

It will be apparent to those skilled in the art that various modifications and variations can be made to the present invention without departing from the spirit or scope of the invention. Thus, it is intended that the present invention covers modifications and variations of this invention provided they come within the scope of the appended claims and their equivalents.

What is claimed is:

1. A method of predicting the performance of an optical member under exposure to ultraviolet radiation in optical systems including a laser operating at wavelength range between 100 and 400 nm comprising measuring the laser induced wavefront change of a sample of the optical member at the operating wavelength of the optical system and estimating the performance of the optical member over an extended period of use of the optical system.

2. The method of claim 1, further including determining the contribution of the photorefractive effect on the wavefront change of the sample.

3. The method of claim 1, wherein the wavefront change is measured with an interferometer at a wavelength of 193 nm.

4. The method of claim 1, wherein the wavefront change is measured with an interferometer at a wavelength of 248 nm.

5. A method of manufacturing fused silica glass optical members used in optical systems including a laser operating at a wavelength range between 100 and 400 nm comprising, manufacturing synthetic fused silica, measuring the laser induced wavefront change in a test sample of fused silica at the operating wavelength of the optical system, measuring at least one other characteristic of the sample, determining a relationship between the wavefront change and the characteristic of the sample, and adjusting the manufacturing process to minimize the wavefront change in the fused silica glass.

6. The method of claim 5, wherein the wavefront change is measured at a wavelength of 193 nm.

7. The method of claim 6, wherein the wavefront change is measured at a wavelength of 248 nm.

8. The method of claim 5, further including determining the contribution of the photorefractive effect to the wavefront change.

9. The method of claim 8, further including changing a glass characteristic to modify the photorefractive effect.

10. The method of claim 9, wherein the glass characteristic is hydrogen content, and further including changing the hydrogen content to adjust the photorefractive effect on the wavefront change.

11. A method of designing an optical system including an optical member and a laser operating at a wavelength range between 100 and 400 nm comprising the steps of selecting optical members based on the wavefront changes of sample optical members measured at the operating wavelength of the optical system and using the selected optical member in the system.

12. The method of claim 11, wherein the operating wavelength and the measurement wavelength is 193 nm.

13. The method of claim 11, wherein the operating wavelength and the measurement wavelength is 248 nm.

14. The method of claim 11, further including the step of the determining the contribution of the photorefractive effect to the wavefront change.

15. A glass optical member exhibiting a predetermined photorefractive effect contribution to wavefront change.

16. The optical member of claim 15, wherein the photorefractive effect value is predetermined by adjusting a glass characteristic.

17. The optical member of claim 16, wherein the hydrogen content of the glass is changed to adjust the photorefractive effect.

18. The optical member of claim 16, wherein the optical member has a preselected wavefront distortion value.

19. A fused silica optical member exhibiting an optimized photorefractive effect so that the optical member exhibits an index change of less than 5 ppm when exposed to a laser operating at a 193 nm and a fluence of 0.5 mj/cm²/pulse.

20. The fused silica optical member of claim 19, wherein the optical member exhibits an index change of less than 2.5 ppm when exposed to a laser operating at a 193 nm and a fluence of 0.4 mj/cm²/pulse.

21. The fused silica optical member of claim 19, wherein the optical member exhibits an index change of less than 1 ppm when exposed to a laser operating at a 193 nm and a fluence of 0.5 mj/cm²/pulse.
